(19) United States
(12) Patent Application Publication
(10) Pub. No.: US 2005/0262144 A1
(43) Pub. Date: Nov. 24, 2005

(54) METHOD AND APPARATUS FOR INDEXING MULTIMEDIA DATA

(76) Inventors: Chih-Wei Teng, Taipei City (TW); Chih-Chiang Shen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,188

(22) Filed: May 2, 2005

(30) Foreign Application Priority Data
May 6, 2004 (TW) 093112752

(51) Int. Cl. G06F 7/00

(52) U.S. Cl. 707/104.1

(57) ABSTRACT

An indexing method for indexing a plurality of multimedia data sets stored in a first storage area includes the following steps: producing an index file according to a predetermined section of target multimedia data, and storing the index file in a second storage area; and comparing the index file with the plurality of multimedia data sets. If a similarity of the index file and a predetermined section of a particular multimedia data set is greater than a predetermined first threshold, the particular multimedia data set is determined to be the target multimedia data.

### BACKGROUND OF INVENTION

1. Field of the Invention

The invention relates to accessing stored multimedia data, and more particularly, to a method and apparatus for locating multimedia data using index files generated from indexing stored multimedia data sets.

2. Description of the Prior Art

With the continued development in the field of multimedia, new advances and consumer uses are producing different user requirements. Furthermore, the storage and playback of multimedia data is increasingly performed using digital processes. As such, a user can retrieve desired content from stored multimedia data according to their requirements. For example, conventional fast forward and rewind functions can be used to search for and retrieve target data. However, when using the conventional fast forward and rewind functions to search for data, the user is only able to use a manual search method to find a desired multimedia section. The user must continuously look at the displayed image on a screen to locate the desired section of the program and determine when to stop. Therefore, the conventional searching functions are unable to provide the user with an optimal searching interface. For example, the conventional searching functions are unable to search for multimedia data desired by the user according to different titles or sections. In addition, using the manual method to perform the searching operation requires the user to waste a large amount of time. As mentioned above, due to the development of the DVD+RW and DVD-RW standards in addition to the common usage of hard disks, high-capacity data storage media are gradually being used in various types of electronic products such as digital-video playback devices. Using these playback devices, the user is able to record different programs broadcast on different channels. Therefore, providing the user with a convenient method to retrieve desired multimedia data from a huge amount of stored multimedia data is an increasingly important operation.

### SUMMARY OF INVENTION

One objective of the claimed invention is therefore to provide a method and apparatus of locating multimedia data using index files generated from indexing stored multimedia data sets, to solve the above-mentioned problems.

According to an exemplary embodiment of the claimed invention, an indexing method is disclosed for indexing a plurality of multimedia data sets stored in a first storage area. The indexing method comprises the following steps: (a) producing an index file according to a predetermined section of target multimedia data, and storing the index file in a second storage area; and (b) comparing the index file with the plurality of multimedia data sets, and if a similarity of the index file and a predetermined section of a particular multimedia data set is greater than a predetermined first threshold, determining the particular multimedia data set to be the target multimedia data.

According to another exemplary embodiment of the claimed invention, a data indexing apparatus is disclosed for indexing a plurality of multimedia data sets stored in a first storage area. The data indexing apparatus comprises a second storage area for storing data; an index producing module electrically coupled to the first and second storage areas for producing an index file according to a predetermined section of target multimedia data, and storing the index file in a second storage area; and a comparing unit electrically coupled to the first and second storage areas for comparing the index file with the plurality of multimedia data sets; wherein if a similarity of the index file and a predetermined section of a particular multimedia data set is greater than a predetermined first threshold, the comparing unit determines the particular multimedia data set to be the target multimedia data.

The present invention indexing method and apparatus use a section of target multimedia data to make an index file. The index file is compared with sections of stored multimedia data. According to the similarity of the index file with the compared sections, target multimedia data can be retrieved. In other words, the user searches for related titles or sections according to the content of an index file. Additionally, the method can be used to automatically search for user desired target multimedia data and does not require a manual section by section search to be performed by the user. Because of this, the present invention indexing method and apparatus greatly reduce searching time.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a functional block diagram of a data indexing apparatus according to the present invention.

FIG. 2 shows a flowchart describing the operations of the data indexing apparatus of FIG. 1.

### DETAILED DESCRIPTION

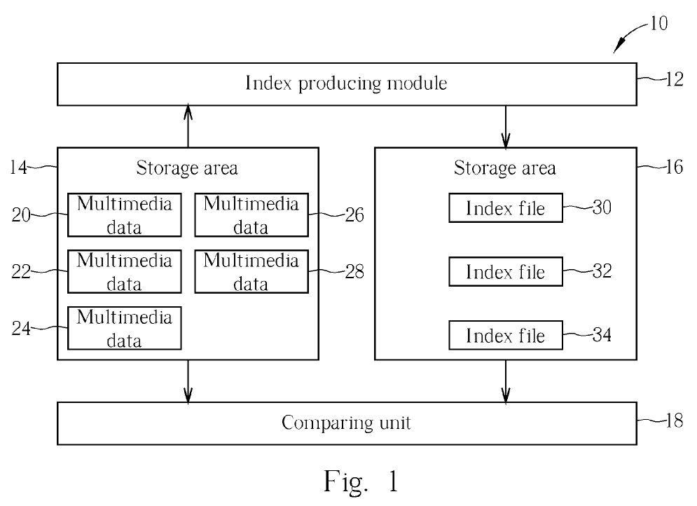

Please refer to FIG. 1. FIG. 1 shows a functional block diagram of a data indexing apparatus 10 according to the present invention. The data indexing apparatus 10 is used to index multimedia data and includes an index producing module 12, a plurality of storage areas 14, 16, and a comparing unit 18. Storage area 14 stores a plurality of multimedia data sets 20, 22, 24, 26, 28. The index producing module 12 is electrically coupled to storage area 14 and storage area 16 for producing a plurality of index files 30, 32, 34 according to a predetermined segment of each multimedia data set 20, 22, 24, 26, 28 stored in storage area 14. The index producing module 12 then stores these index files 30, 32, 34 in storage area 16. The comparing unit 18 is electrically coupled to storage area 14 and storage area 16 for comparing the index files 30, 32, 34 stored in storage area 16 with the multimedia data sets 20, 22, 24, 26, 28 stored in storage area 14. In this embodiment of the present invention, the multimedia data sets 20, 22, 24, 26, 28 include respective image data, and the index files 30, 32, 34 include starting sections or ending sections extracted from the image data corresponding to the multimedia data sets 20, 22, 24, 26, 28. The comparing unit 18 compares pixel values of a displayed image recorded in the index files 30, 32, 34 with pixels values of display images recorded in the multimedia data sets 20, 22, 24, 26, 28. Please note, in this embodiment, the storage areas 14, 16 shown in FIG. 1 are used separately to store the multimedia data sets 20, 22, 24, 26, 28 and the index files 30, 32, 34. These storage areas 14, 16 could be implemented using separate non-volatile memories (for example, hard disks). However, the present invention is not limited to this configuration. For example, in another embodiment, the storage areas 14, 16 could also be implemented using a single non-volatile memory.

To help further explain the present invention, assume the data indexing apparatus 10 is used in a digital-video playback device. As is commonly known, both cabled and wireless television broadcast stations start the majority of all programs at the beginning of each hour. Furthermore, each program includes a title screen in a starting section of the program that informs the audience the program has officially started. Additionally, an ending section of the program displays credits for the program. Generally speaking, the above-mentioned program starting and ending sections have fixed content. For example, daily news programs will each day report different news items, however, when the news program is broadcast at the same time each day, the same starting and ending sections are repeated. Therefore, the data indexing apparatus 10 is able to assist in data searching operations to retrieve target multimedia data according to information included in the program starting or ending sections.

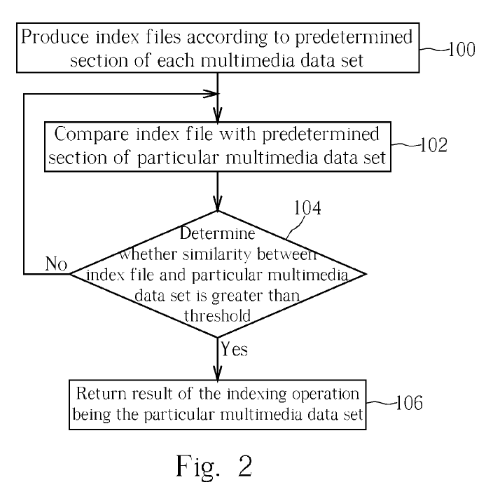

Please refer to FIG. 2. FIG. 2 shows a flowchart describing the operations of the data indexing apparatus 10. The flowchart contains the following steps:

Step 100: Produce a plurality of index files 30, 32, 34 according to a predetermined section of each multimedia data set 20, 22, 24, 26, 28 stored in storage area 14. Store these index files 30, 32, 34 in storage area 16.

Step 102: Compare an index file 30, 32, 34 corresponding to target multimedia data desired by the user with a predetermined section of a particular multimedia data set stored in storage area 14.

Step 104: Determine whether the similarity between the index file and the predetermined section of the particular multimedia data set is greater than a predetermined threshold. If the similarity is greater than the predetermined threshold, proceed to step 106; otherwise, return to step 102 and continue comparing the index file with another particular multimedia data set stored in storage area 14.

Step 106: Complete the indexing operation by returning the result of the indexing operation being the particular multimedia data set corresponding to the index file, which is the target multimedia data desired by the user.

For example, assume the multimedia data sets 20, 22, 24, 26, 28 are multimedia data sets corresponding to a plurality of programs recorded by a digital-video playback device and include both image and audio information. More specifically, multimedia data sets 20, 26, 28 correspond to different broadcast times of a first program, multimedia data set 22 corresponds to a second program, and multimedia data set 24 corresponds to a third program. Additionally, the first, second, and third programs each have predetermined starting and ending sections. Taking the program starting sections forming the index files for example, the present invention data indexing apparatus 10 creates an index file at the beginning of each hour. When the first program starts broadcasting at a predetermined hour, the data indexing apparatus 10 begins recording the corresponding first program multimedia data set 20, and the index producing module 12 produces the first index file 30 according to the starting section of the first program (step 100). This is performed, for example, by extracting a starting section of multimedia data set 20 to produce index file 30. According to the length of the starting section, the index file 30 can include all of the information of the starting section of the first program or only a part of the information. Similarly, the index producing module 12 produces index file 32 according to the starting section of the second program, and produces index file 34 according to the starting section of the third program. Please note that the first, second, and third programs are different programs. As such, they have different starting sections. In other words, the index files 30, 32, 34 correspond to different image segments, and therefore, record different image data. However, as mentioned above, multimedia data sets 20, 26, 28 correspond to different broadcast times of the same first program. Therefore, when the data indexing apparatus 10 is recording multimedia data set 26 corresponding to the first program, index producing module 12 produces an index file according to the starting section of the first program. In theory, this index file and the already recorded index file 30 in storage area 16 will contain the same image data. Therefore, in this embodiment, if storage area 16 already contains a particular index file, and if a similarity between a current index file and the particular index file produced by the data indexing apparatus 10 is greater than a second predetermined threshold, the current index file overwrites the particular index file in storage area 16. In this situation, in another embodiment, the current index file is not stored in storage area 16. The reason for this is to avoid storing multiple copies of index files for the same program in storage area 16. Any duplicate copies of identical index files would unnecessarily occupy some of the limited storage space available in storage area 16. Using the same logic, when the data indexing apparatus 10 is recording multimedia data set 28 corresponding to the first program, the index producing module 12 produces an index file according to the starting section of the first program. Because this index file is very similar with index file 30 already stored in storage area 16, in this embodiment, the newly produced index file overwrites index file 30. In another embodiment, the newly produced index file will not be stored in storage area 16. As shown in FIG. 1, although the digital-video playback device records five sets of multimedia image data 20, 22, 24, 26, 28 corresponding to different times, storage area 16 will only record index files 30, 32, 34 corresponding to the different first, second, and third programs.

When the user has viewed a particular multimedia data set already stored in storage area 14 and then wants to re-view the multimedia data set, the data indexing apparatus 10 can use index files 30, 32, 34 to search for the target multimedia data set. Assume the user has just viewed multimedia data set 20 from storage area 14. In this situation, the comparing unit 18 first uses index file 30 to compare with the multimedia data set 20 of storage area 14 (step 102). The comparing unit 18 then determines whether the similarity between index file 30 and a predetermined section (i.e., the starting section) of the multimedia data set 20 is greater than a predetermined first threshold (step 104). Because the starting section of the multimedia data set 20 corresponds to index file 30, the comparing unit 18 determines the multimedia data set 20 is the indexing result of index file 30. Therefore, the indexing operation is complete (step 106).

Additionally, if the user wants to watch recorded broadcast content of the first program at a different time (for example, target multimedia data being multimedia data set 26), the comparing unit 18 returns to step 102 to compare index file 30 and a predetermined section (i.e., the starting section) of the next multimedia data set 22. In step 104, the comparing unit 18 determines if the similarity between the index file 30 and the predetermined section of the next multimedia data set 22 is greater than the first threshold. As previously stated, multimedia data set 22 corresponds to index file 32 and not index file 30. Hence, the comparing unit 18 returns to step 102 to continue comparing index file 30 and a predetermined section (i.e., the starting section) of the next multimedia data set 24 to determine if the similarity is greater than the first threshold (step 104). Because the multimedia data set 24 corresponds to index file 34 and not index file 30, the comparing unit 18 again returns to step 102 to continue comparing index file 30 and a predetermined section (i.e., the starting section) of the next multimedia data set 26 to determine if the similarity is greater than the first threshold (step 104). As previously stated, the starting section of the multimedia data set 26 corresponds to index file 30. Therefore, the comparing unit 18 determines the multimedia data set 26 is the indexing result of index file 30, and the indexing operation is completed (step 106). Please note, if the user continues viewing and later wants to watch the broadcast content from the first program at another time (for example, target multimedia data being multimedia data set 28), the above described procedure is again performed.

In this embodiment, in step 102, the comparing order of the particular multimedia data set stored in storage area 14 is chosen according to the multimedia data sets 20, 22, 24, 26, 28 in order from first to last starting with multimedia data set 20. However, it is also possible to perform these comparisons according to another order. For example, the comparisons could also be performed starting from the last multimedia data set and proceeding to the first. In addition, as already stated, each multimedia data set 20, 22, 24, 26, 28 further includes audio information. Therefore, the present invention could also use the corresponding audio information of the starting section or the ending section of the multimedia data to become the index file. Such alternations form other embodiments supported by the present invention.

The present invention indexing method and apparatus use a section of target multimedia data to make an index file. The index file is compared with sections of stored multimedia data. According to the similarity of the index file with the compared sections, target multimedia data can be retrieved. In other words, the user searches for related titles or sections according to the content of an index file. Additionally, the method can be used to automatically search for user desired target multimedia data and does not require a manual section by section search to be performed by the user. Because of this, the present invention indexing method and apparatus greatly reduce searching time.

Those skilled in the art will readily observe that numerous modifications and alterations of the device may be made while retaining the teachings of the invention. Accordingly, the above disclosure should be construed as limited only by the metes and bounds of the appended claims.

1. An indexing method for indexing a plurality of multimedia data sets stored in a first storage area, the indexing method comprising the following steps:
(a) producing an index file according to a predetermined section of a target multimedia data, and storing the index file in a second storage area; and
(b) comparing the index file with the plurality of multimedia data sets, and if a similarity of the index file and a predetermined section of a particular multimedia data set is greater than a predetermined first threshold, determining the particular multimedia data set to be the target multimedia data.

2. The indexing method of claim 1, wherein the multimedia data comprises image data, and step (b) further comprises comparing pixel values recorded in the index file with pixel values recorded in the image data of the plurality of multimedia data sets.

3. The indexing method of claim 2, wherein the predetermined section is a starting section of the image data.

4. The indexing method of claim 4, wherein the predetermined section is an ending section of the image data.

5. The indexing method of claim 1, wherein the multimedia data comprises audio data, and the predetermined section is a starting section of the audio data.

6. The indexing method of claim 1, wherein the multimedia data comprises audio data, and the predetermined section is an ending section of the audio data.

7. The indexing method of claim 1, wherein step (a) further comprises if the second storage area already includes a particular index file before the index file is stored in the second storage area, and if a similarity between the index file and the particular index file is greater than a second threshold, overwriting the particular index file when storing the index file in the second storage area.

8. The indexing method of claim 1, wherein step (a) further comprises if the second storage area already includes a particular index file before the index file is stored in the second storage area, and if a similarity between the index file and the particular index file is greater than a second threshold, not storing the index file in the second storage area.

9. An data indexing apparatus for indexing a plurality of multimedia data sets stored in a first storage area, the data indexing apparatus comprising:
a second storage area for storing data;
an index producing module electrically coupled to the first and second storage areas for producing an index file according to a predetermined section of target multimedia data, and storing the index file in a second storage area; and
a comparing unit electrically coupled to the first and second storage areas for comparing the index file with the plurality of multimedia data sets; wherein if a similarity of the index file and a predetermined section of a particular multimedia data set is greater than a predetermined first threshold, the comparing unit determines the particular multimedia data set to be the target multimedia data.

10. The data indexing apparatus of claim 9, wherein the multimedia data comprises image data, and the comparing unit compares pixel values recorded in the index file with pixel values recorded in the image data of the plurality of multimedia data sets.

11. The data indexing apparatus of claim 10, wherein the predetermined section is a starting section of the image data.

12. The data indexing apparatus of claim 10, wherein the predetermined section is an ending section of the image data.

13. The data indexing apparatus of claim 9, wherein the multimedia data comprises audio data, and the predetermined section is a starting section of the audio data.

14. The data indexing apparatus of claim 9, wherein the multimedia data comprises audio data, and the predetermined section is an ending section of the audio data.

15. The data indexing apparatus of claim 9, wherein the second storage area is located in a non-volatile memory.

16. The data indexing apparatus of claim 15, wherein the non-volatile memory is a hard disk.

17. The data indexing apparatus of claim 15, wherein both the first and the second storage areas are located in the non-volatile memory.

18. The data indexing apparatus of claim 9, wherein if the second storage area already includes a particular index file before the index file is stored in the second storage area, and if a similarity between the index file and the particular index file is greater than a second threshold, the particular index file is overwritten when storing the index file in the second storage area.

19. The data indexing apparatus of claim 9, wherein if the second storage area already includes a particular index file before the index file is stored in the second storage area, and if a similarity between the index file and the particular index file is greater than a second threshold, the index file is not stored in the second storage area.
